(19) United States
(12) Patent Application Publication
(10) Pub. No.: US 2008/0007313 A1
(43) Pub. Date: Jan. 10, 2008

(54) Digital clock generator

(76) Inventor: Kevin Chiang, Fremont, CA (US)

Correspondence Address: Kevin Chiang, 40734 Ambal Place, Fremont, CA, 94539, US

(21) Appl. No.: 11/801,022

(22) Filed: May 8, 2007

Related U.S. Application Data
(60) Provisional application No. 60/798,505, filed on May 8, 2006.

(51) Int. Cl. G06F 1/04

(52) U.S. Cl. 327/299

(57) ABSTRACT

A digital clock generator uses an on-chip digital delay chain to generate clock signal with variable frequency. An external charging circuit with variable charge rate may be used to select target frequency by generating digital pulse with variable width. An external reference clock may be used to calibrate the digital clock frequency. The external reference clock may be enabled only for calibration.

### CROSS-REFERENCE TO RELATED APPLICATIONS

This application claims the benefit of provisional patent Appl No. 60/798,505 filed 2006 May 08 by the present inventor.

### FIELD OF THE INVENTION

This invention relates generally to clock generation circuits, and more specifically to a digital clock generation circuit without reference clock, and more specifically to a clock generation circuit adjusted by external resistor and capacitor.

### BACKGROUND OF THE INVENTION

Clock generation circuits are commonly used in digital data processing devices. In general, a phase-locked loop is used to generate this clock signal. Phase-locked loop designs typically rely on external reference clock signals, and internally use voltage controlled oscillators (VCO). In U.S. Pat. No. 5,173,617, the PLL-based clock generator does not rely on VCO, but still depends on external reference clock. External reference clocks driven by digital I/O pad oscillating at high frequencies wastes power, and are fragile and vulnerable to vibration or other environmental hazards. In Linear Technology's LTC6905 resistor set oscillator, the external clock is replaced with a resistor. The analog voltage differential across the resistor is used to control internal oscillation frequency. However, the LTC6905 uses analog circuit elements. It would be of significant benefit and convenience if a clock generator could be designed without requiring use of external reference clock, and without any analog design involved.

### SUMMARY OF THE INVENTION

One object of the present invention is to provide an entirely digital clock generation method that does not use external reference clock. This object is achieved by using external charging circuit, typically resistor with capacitor (RC circuit) connected to normal digital I/O pad, to change width of an internally generated pulse. The external charging circuit can be enabled only when the frequency settings changes, otherwise conserving power while disabled. This pulse width is measured, with the result subsequently used to select desired output clock signal from a recirculation chain of delay elements. The resulting output clock signal is proportional to pulse width.

Another object of the present invention is to provide an entirely digital clock generation method, with an external reference clock only selectively enabled for calibration of the internal reference clock when needed.

### BRIEF DESCRIPTION OF THE DRAWINGS

FIG. 1 is the digital clock signal generator architecture.

FIG. 2 is a waveform showing pulse construction using RC circuit.

FIG. 3 is a pulse width measurement circuit.

FIG. 4 is a RC circuit charging curve.

FIG. 5 is a clock waveform.

FIG. 6 is an example of a selectable delay circuit.

FIG. 7A is an example of digital clock signal generator.

FIG. 7B is the waveform for design in FIG. 7A.

FIG. 8A is another example of digital clock generator.

FIG. 8B is waveform for circuit in FIG. 8A with 6 delay stages.

FIG. 9 is a clock signal generator, with external crystal enabled for frequency calibration only.

### DESCRIPTION OF THE PREFERRED EMBODIMENT

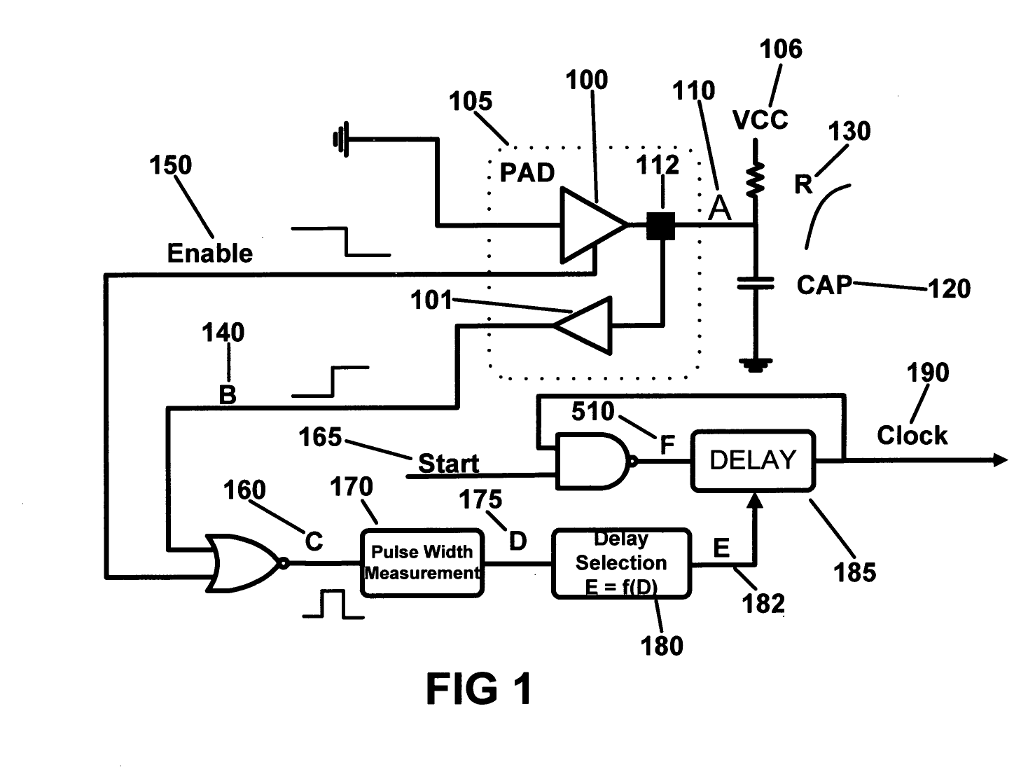

FIG. 1 is an illustration of digital clock signal generator with variable resistor for adjusting output clock frequency. PAD 105 is a standard digital 10 pad. Enable 150 is use to turn on Output Buffer 100 of PAD 105. Setting Enable 150 to 1 turns on Output Buffer 100, and changing Enable to 0 turns off Output Buffer 100. The External Contact 112 of PAD 105 connects to an external variable Resistor R 130. Capacitor CAP 120 can be external or pin capacitor from PAD 105.

When initialized, A 110 is 0 with Enable 150 set to 1. When Enable 150 changes to 0, Output Buffer 100 is disabled, and A 110 starts to increase due to positive voltage charge VCC 106 through Resistor R 130. The rate at which A 110 rises depends on value of Resistor R 130. When A 110 reaches threshold voltage of Input Buffer 104, then output B 140 changes from 0 to 1. The timing of the rising edge of output B 140 is therefore also dependent on value of Resistor 130.

C 160 is a pulse, with the width D 175 determined by lag between falling edge of Enable 150 to rising edge of B 140. Therefore, the pulse width of C 160 can be adjusted by change variable Resistor 130. Pulse width D 175 can be measured using Pulse Width Measurement Circuit 170. Delay selection E 182 is a function of D 175. Changing pulse width D 175 by adjusting variable Resistor R130, allows the frequency of the output Clock 190 to be changed.

Voltage at A 110, when Enable 150 is disabled, is dependent on charging of capacitor CAP 120. The equation for this voltage when charging is as follows:
V(t)=Vcc*(1−e^{t/rc})
rc is time constant:
r: resistor in units of ohm.
c: capacitor value in units of Faraday.
t: in units of second.

Assume threshold voltage of buffer 104 is 1.5 v, and Vcc 106 is 3 v, than we have
0.5=1−e^{t/rc} than
e^{-t/rc}=0.5 than
−t/rc=ln □0.5□=−0.69
t=0.69*RC

For fixed c=CAP 120, the time required to reach threshold voltage of input Buffer 104 is linear to value of R 130. This also means the pulse width D 175 is linear to value of R 130.

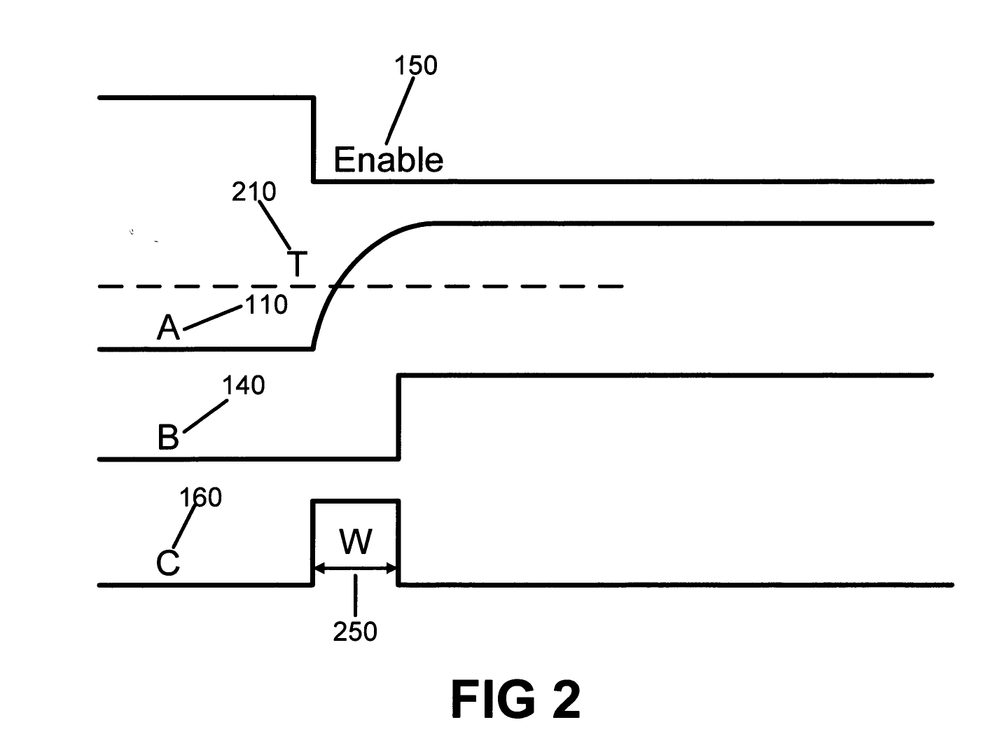

FIG. 2 is a waveform for signals in FIG. 1. The pulse C 160 is generated from Enable 150 and input B 140. The width W 250 of pulse C 160 is a linear function of resistance R 130 in the charging circuit.

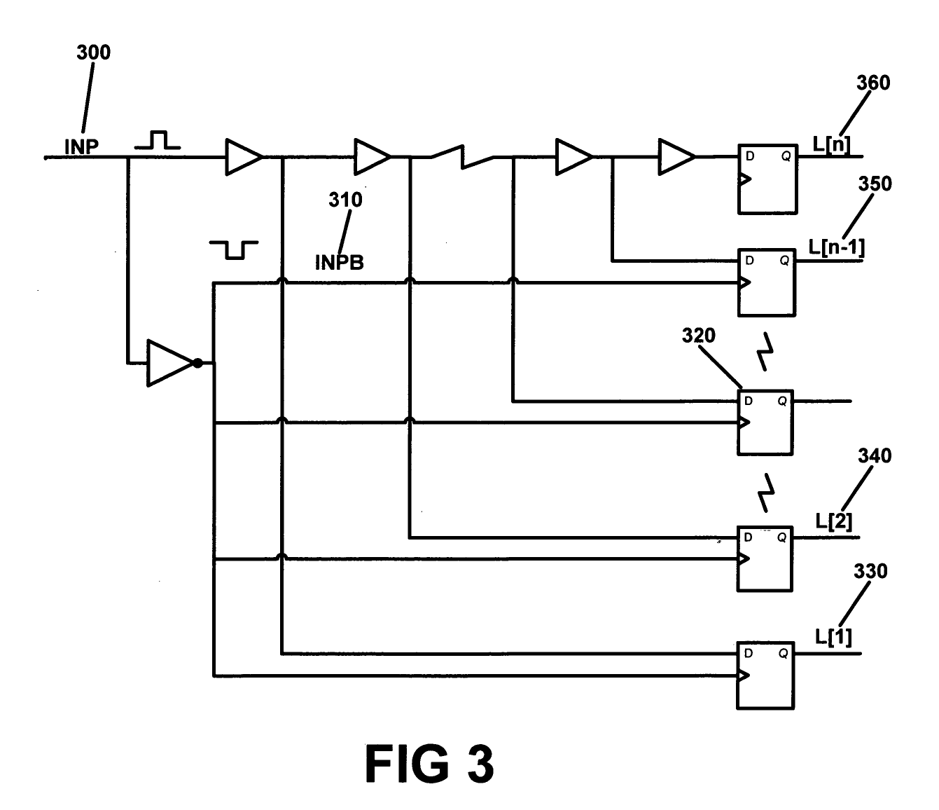

FIG. 3 is a pulse width measurement circuit, such as that used in FIG. 1. The signal INP 300 is delayed by a chain of delay buffers. INPB 310 is the inverted version of INP 300. The rising edge of INPB 310 latches each of the delay buffers in the chain at Latch 320. Counting the number of Is in the latched values L[1] 330 to L[n] 360 gives us the width information.

$$W = {\sum }_{x = 1}^{n} L [ x ]$$

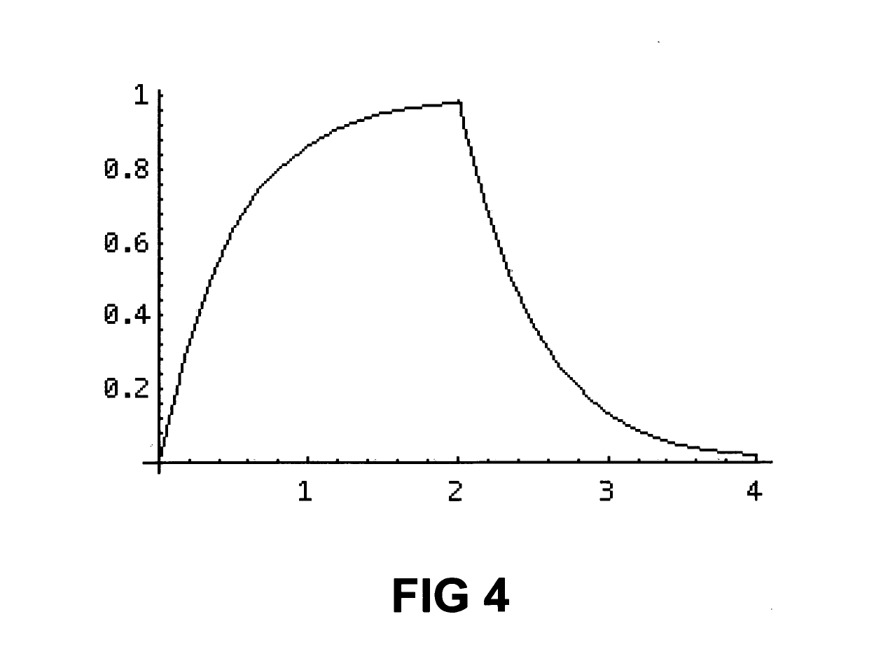

FIG. 4 is the RC circuit charging curve, showing change in voltage versus time when a new external voltage is applied.

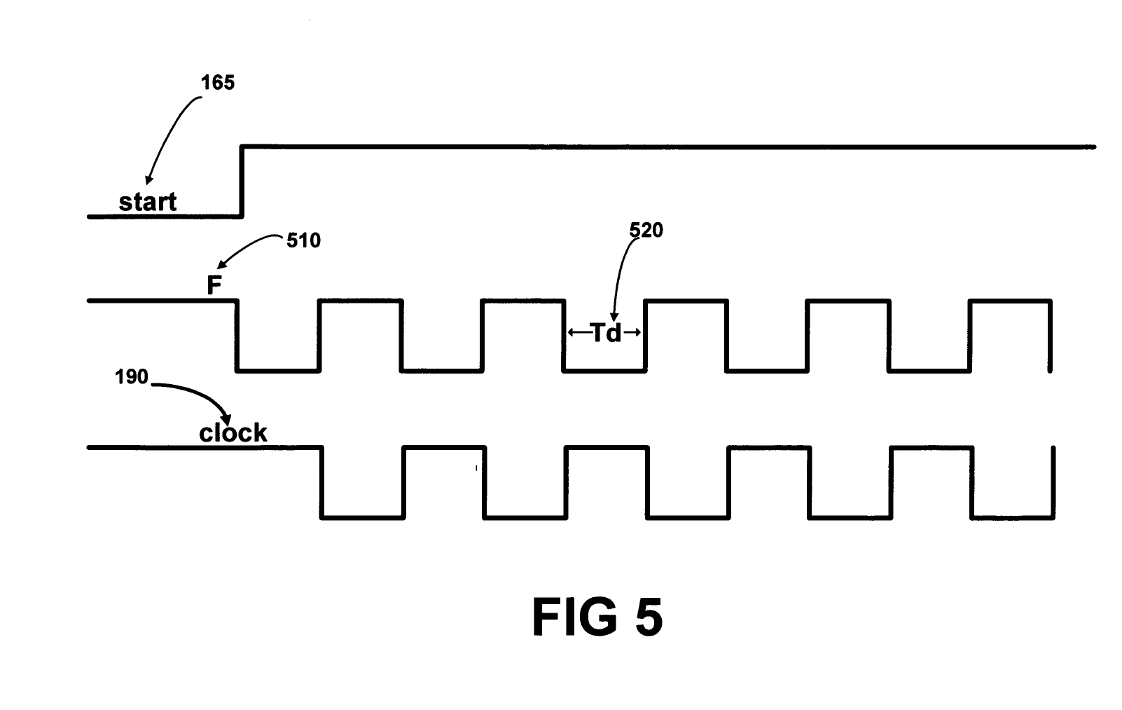

FIG. 5 is clock waveform for key signals from FIG. 1. When Start 165 is low, F 510 is high. When start 165 change to high, the delay with feedback circuit begins to generate Clock 190. The timing of Td 520 (half cycle width) is selected by E 182.

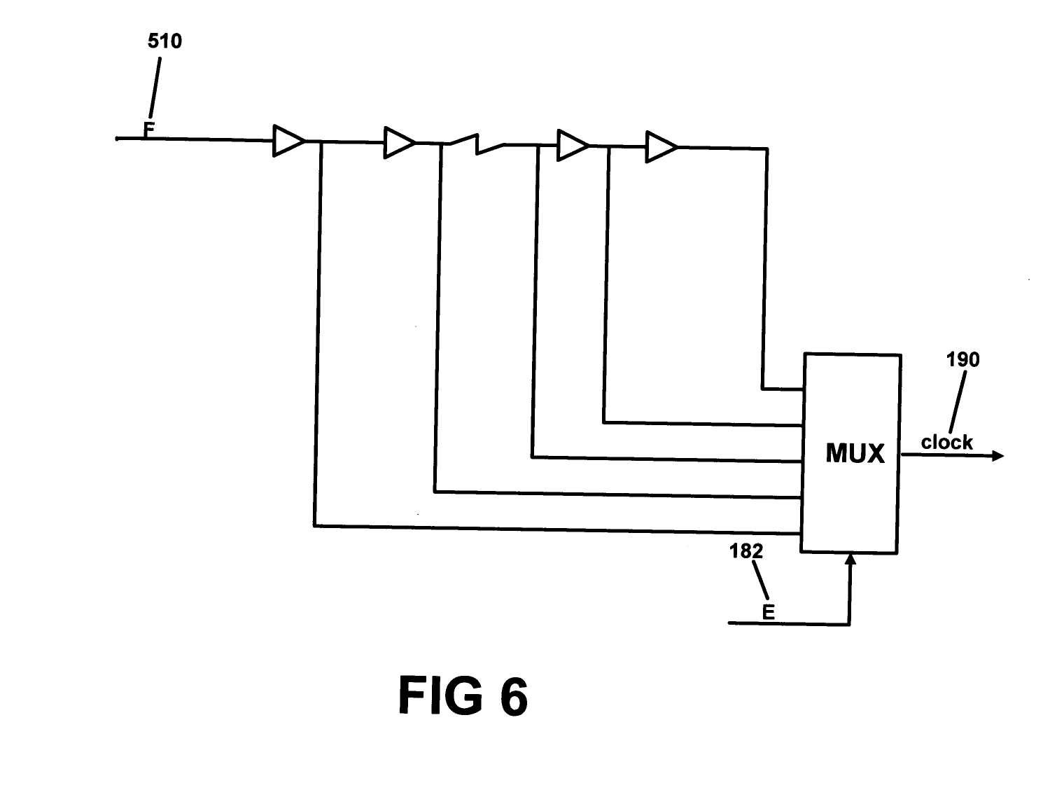

FIG. 6 is the architecture of a delay block DELAY 185 in FIG. 1. Input signal F 510 is delayed by a chain of identical delay buffers. The Clock 190 is selected from one of the delayed output signals by E 182.

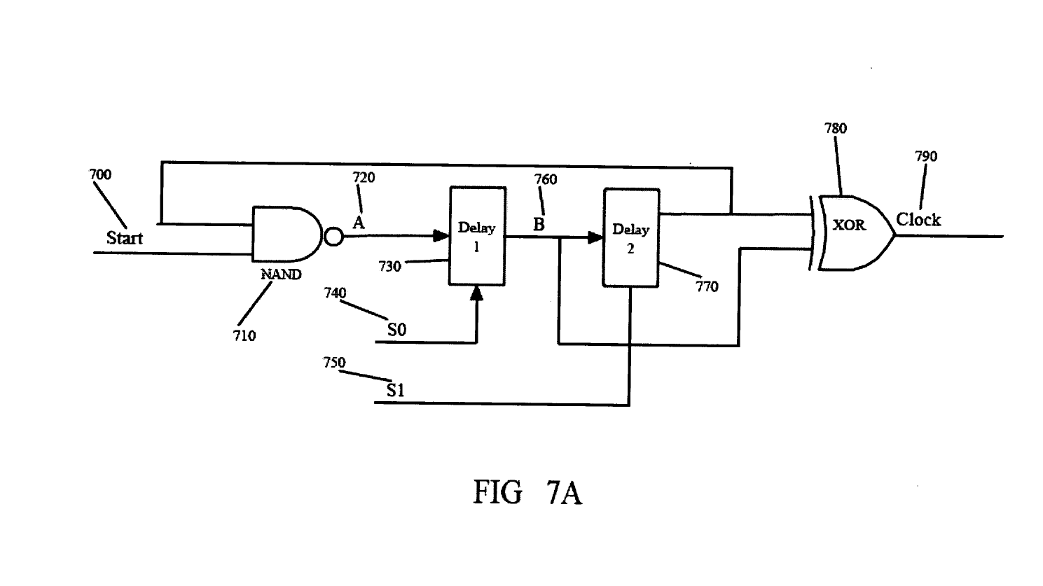

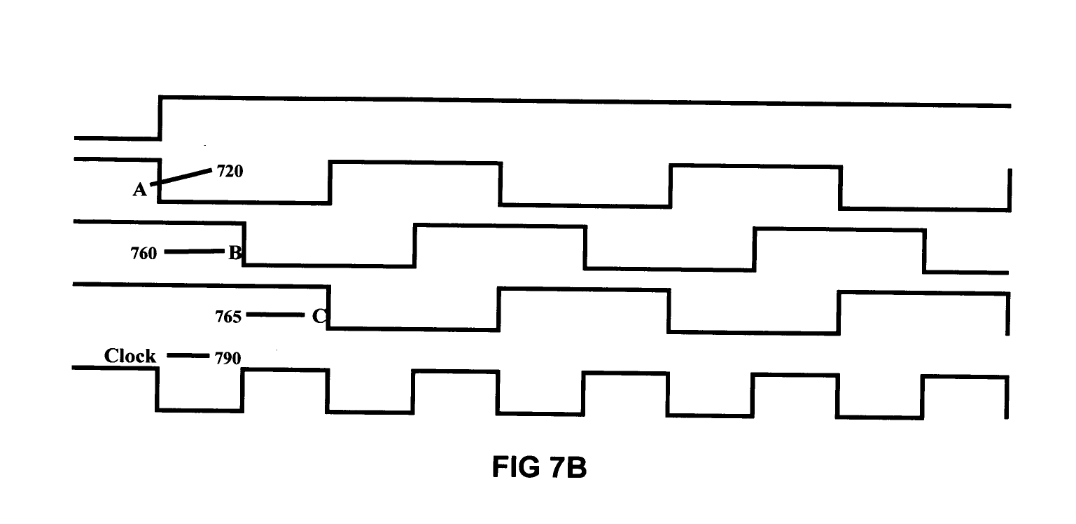

FIG. 7A is an example of another clock generator. The duty cycle can be different, and selected by SO 740 and S1 750.

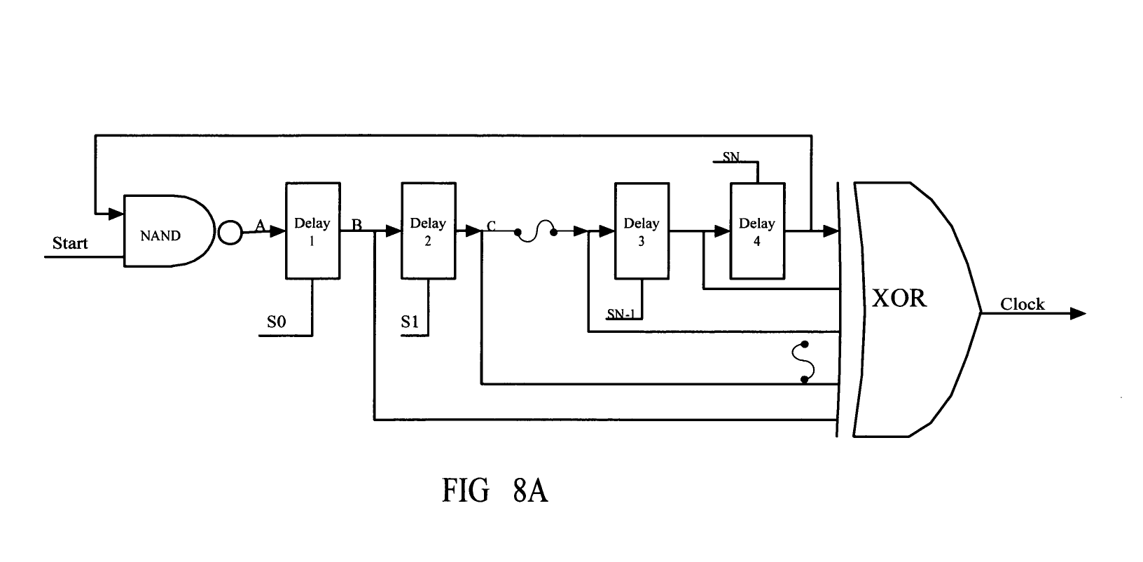

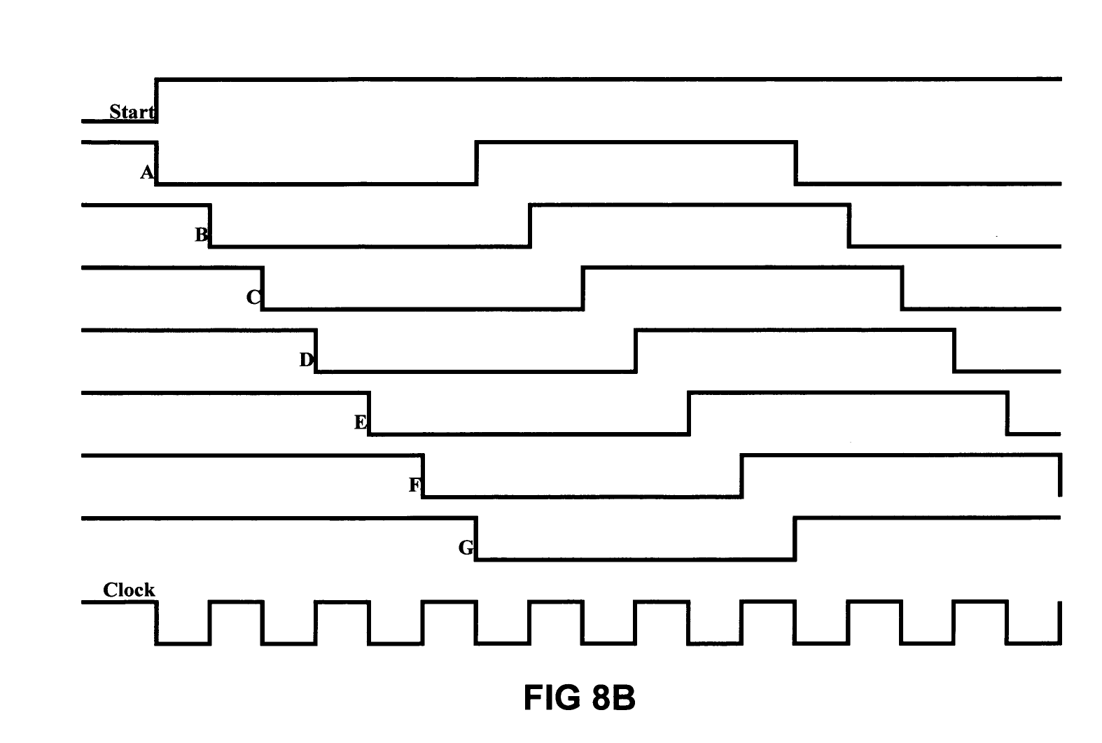

FIG. 7B shows the waveform for FIG. 7A. po FIG. 8A is a general form of FIG7A, allowing for any number n of delay blocks. FIG. 8B is a waveform for a 6 delay block.

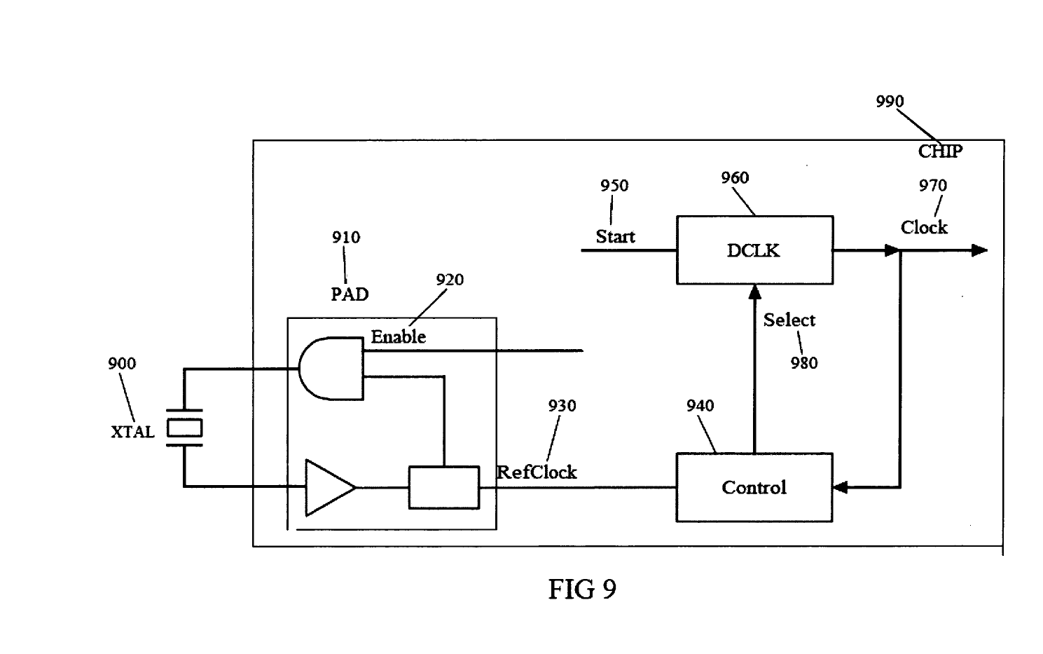

FIG. 9 is another digital clock circuit allowing use of external crystal for frequency calibration. The XTAL 900 pad can be enabled for measurement by setting Enable 920 to 1, in which case XTAL 900 receives power voltage, and outputs signal into Ref Clock 930. Otherwise, XTAL 900 can be disabled by setting Enable 920 to low to reduce power consumption. Compared to traditional phase-locked loop timing circuits, a slower frequency XTAL 900 crystal can be used in this circuit; this also reduces the power consumption.

We claim:

1. A method to generate clock signal for use in electronic digital circuits comprising:
Enabling charging circuit with digital control signal,
Toggling a digital buffer output as input connected to charging circuit rises above threshold voltage,
Combining enable signal with output from digital buffer to form pulse,
Measuring pulse to determine current pulse width,
Selecting output from recirculation delay chain based on measured pulse width.

2. A method according to claim 1, wherein the external charging circuit is disabled when frequency setting is unchanged.

3. A method to generate clock signal with variable duty cycle for use in electronic digital circuits comprising:
Selecting a width for the high phase of output clock signal with one input connected to a recirculation delay chain,
Selecting a width for the low phase of output clock signal with second input connected to a second recirculation delay chain.

4. A method according to claim 3, wherein more than two recirculation delay chains can be used to generate clock signal with variable duty cycles for multiple periods.

5. A method for calibrating the clock signal generated from a digital circuit comprising:
Driving reference signal from external crystal,
Measuring external reference clock for a known period of time using digital counters,
Measuring current clock signal output for a known period of time, using digital counters,
Comparing the measurements from both clock signals,
Adjusting the clock signal generator by either accelerating or decelerating the clock signal until target frequency is achieved.

6. A method according to claim 5, wherein external crystal is enabled by digital output signal.
